(19) United States
(12) Patent Application Publication
(10) Pub. No.: US 2011/0283204 A1
(43) Pub. Date: Nov. 17, 2011

(54) Pasting Various Data into a Programming Environment

(75) Inventors: Charles Edward Jacobs, Seattle, WA (US); Sumit Basu, Redmond, WA (US); John C. Platt, Bellevue, WA (US)

(73) Assignee: Microsoft Corporation, Redmond, WA (US)

(21) Appl. No.: 12/778,157

(22) Filed: May 12, 2010

(51) Int. Cl. G06F 3/048; G06F 3/00

(52) U.S. Cl. 715/762; 715/772; 715/770; 715/780

(57) ABSTRACT

Described is a technology by which a user pastes selected data into a command line of a program, including when the selected data is non-textual. Upon detecting the paste (or drop) action, a variable name is automatically generated and inserted at the current point in a command line, where it acts as a proxy for the pasted data itself. A data structure comprising the selected data or transformed data corresponding to that selected data is maintained in program storage, e.g., RAM allocated to the program. In one aspect, a handler may be used to transform the data from one format into another that may be used by a particular program. For example, text may be reformatted into an array on which the program operates. The handler may be selected from a plurality of possible handlers, including customized handlers.

### BACKGROUND

When working in an interactive programming environment, such as one that only accepts text at a command prompt, (sometimes referred to as a Read-Eval-Print-Loop or REPL environment), users have to type in or paste text into the command line. Often, users want to perform an operation on data that is either too large or otherwise impossible to type in at the command prompt (e.g., an image). In this situation, a user instead types in a reference to the location of the data (for instance, a filename or web URL), with the file contents later loaded as data into the environment when appropriate.

However, when the data does not already reside in a file on disk, the data needs to be somehow saved to the file by the user, including naming the file. Then the filename needs to be remembered and accurately typed in at the command line.

For example, if the user wants to apply a function called “process_image” to an image that is open in a browser such as Internet Explorer, the user typically needs to right-click on or otherwise select the image and choose the “Save As . . . ” operation. The user then has to find a suitable location on the disk to save the image, and give it a filename. At the command prompt of the programming environment, the user then needs to type something like “img=load_image(“C:/Users/Me/MyDocuments/Data/MyImage.jpg”)” before calling the “process_image(img)” function. Unless the user wants to keep the file, the user also needs to remember to find the original image on disk and delete it when no longer needed.

This is quite cumbersome, and error prone, particularly if the filename has a long path.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a user can, for example, cut-and-paste or drag-and-drop selected data, which may be non-textual data, into a data processing/programming environment. This includes a data processing/programming environment that includes a text-only command line. User-selected data is received (e.g., by a paste or drop operation) at a user interface of a program, such as a REPL or other data processing/programming environment. A data structure/data object comprising the selected data or transformed data corresponding to that selected data is maintained in program storage, e.g., RAM allocated to the program. An automatically generated variable name is used to reference the data structure, and the user interface is visually updated to indicate that some action has been taken with respect to the selected data, e.g., when received, the command line of the program may have the variable name inserted as text. The data in the data structure may then be further processed by accessing it via the variable name.

In one aspect, alternatives to receiving selected data from a paste or drop operation including receiving the data from a network communication and/or a data event from another source. For example, the data may be received from a network event from another computer, from a network event from a web service (e.g., a subscription as new data is available), or from an event from another process (e.g., a video capture process that communicates with the program), Other source examples include receiving an event from a web browser, (e.g., a user clicks a “Send to” button/link and the data appears in the data processing/programming environment with an assigned variable name), an event from other device on the computer, such as a flash drive, Bluetooth® device, data reader, and so forth that sends data to the data processing/programming environment, or an email/instant message to the data processing/programming environment.

In one aspect, a handler may be used to transform the data from one format into another that may be used by a particular program. For example, text may be reformatted into an array on which the program operates. The handler may be selected from a plurality of possible handlers, including customized handlers.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example environment for automatically inserting selected data into a programming/data processing environment in response to a paste or drop operation by referencing the data via a variable.

FIG. 2 is representation of a series of user interface screens that are updated as a user pastes or drops data into a programming/data processing environment.

FIG. 3 is a flow diagram representing example steps for processing data pasted or dropped into a programming/data processing environment.

FIG. 4 shows an illustrative example of a computing environment into which various aspects of the present invention may be incorporated.

### DETAILED DESCRIPTION

Various aspects of the technology described herein are generally directed towards allowing a user to effectively insert copied data (e.g., from the system clipboard) into a programming or other data processing environment, including environments having a command prompt for data entry, via a straightforward paste or drag-and-drop operation. In one aspect, upon detecting the paste or drop command, a variable name is automatically generated and inserted at the current point in a command line, where it acts as a proxy for the pasted data itself. Also described are one or more handlers (possibly including extended handlers) that are able to transform the data into a format desired by the application corresponding to the programming/data processing environment.

It should be understood that any of the examples herein are non-limiting. Indeed, while a text-only command line is described because of the benefits and advantages provided by the technology in such an environment, any graphical or other programming/data processing environment may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing in general.

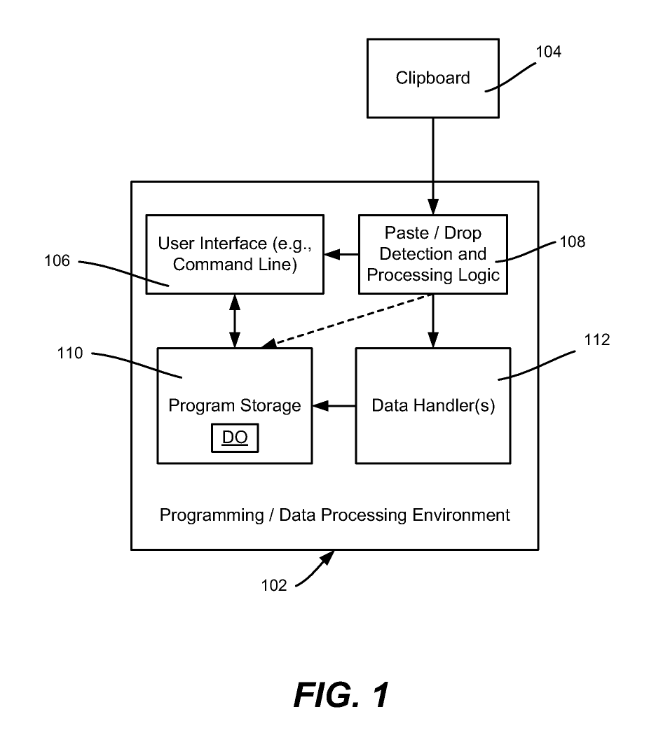

FIG. 1 shows a general example system for pasting non-textual data into an interactive programming/data processing environment 102. In general, the user copies data into a clipboard 104 or the like in any known manner. Note that this includes dragging data, even though doing so does not typically clear the memory used for “copied” clipboard content.

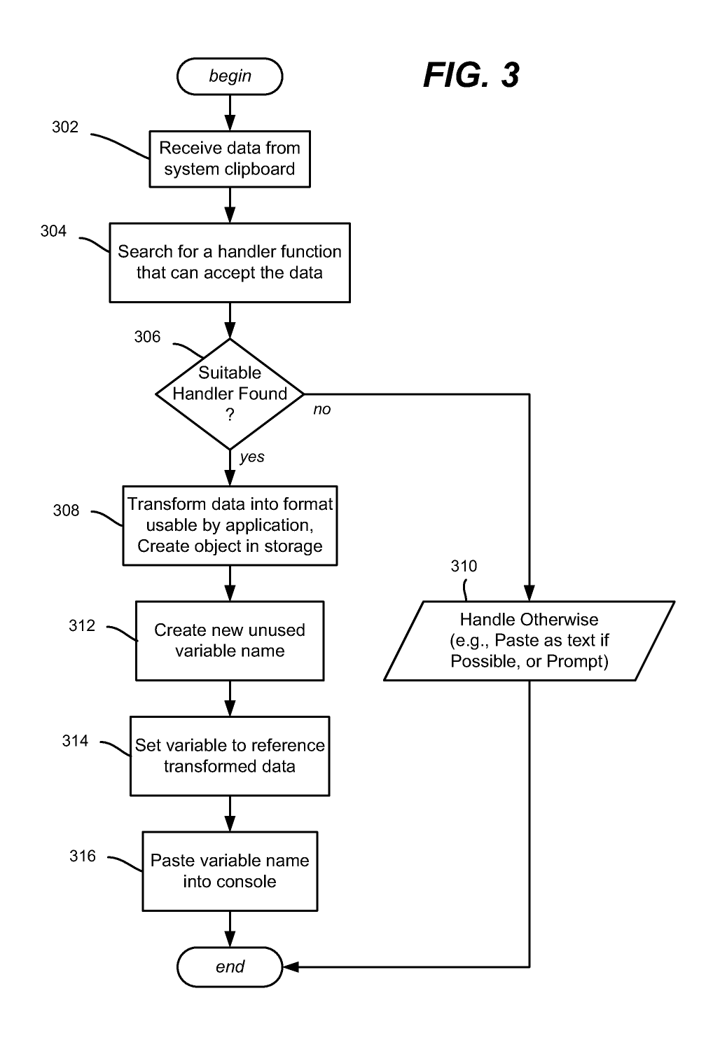

The programming/data processing environment 102 includes a user interface console 106, such as one that can only accept text. As described herein, the programming/data processing environment 102 further includes paste/drop detection and processing logic 108 (also described below with reference to FIG. 3). When via the user interface 106 the user selects the “paste” command (e.g., via ctrl-V or a menu option), or drags some representation of the data into the user interface 106, the data is copied from the clipboard 104 into the programming environment's storage 110, e.g., as a structured data object (DO) in the program's allocated random access memory (but alternatively other media such as a file folder or the like). Before copying the data, the data may be optionally transformed by a data handler 112 as described below.

In addition to inserting (pasting or dropping) the data into the program storage 110, the paste/drop detection and processing logic 108 generates a variable name (e.g., “_var001” or anything not otherwise being used for other data in the current program environment) and has that variable point to the data that has just been pasted. That variable name is also inserted (e.g., as text) into the current point in the command line, where it acts as a proxy for the pasted data itself. Note that while FIG. 1 generally shows the processing logic 108 as part of the program, it can be readily appreciated that the logic part may be called (e.g., via an API or the like) by another program upon detection of a paste or drop.

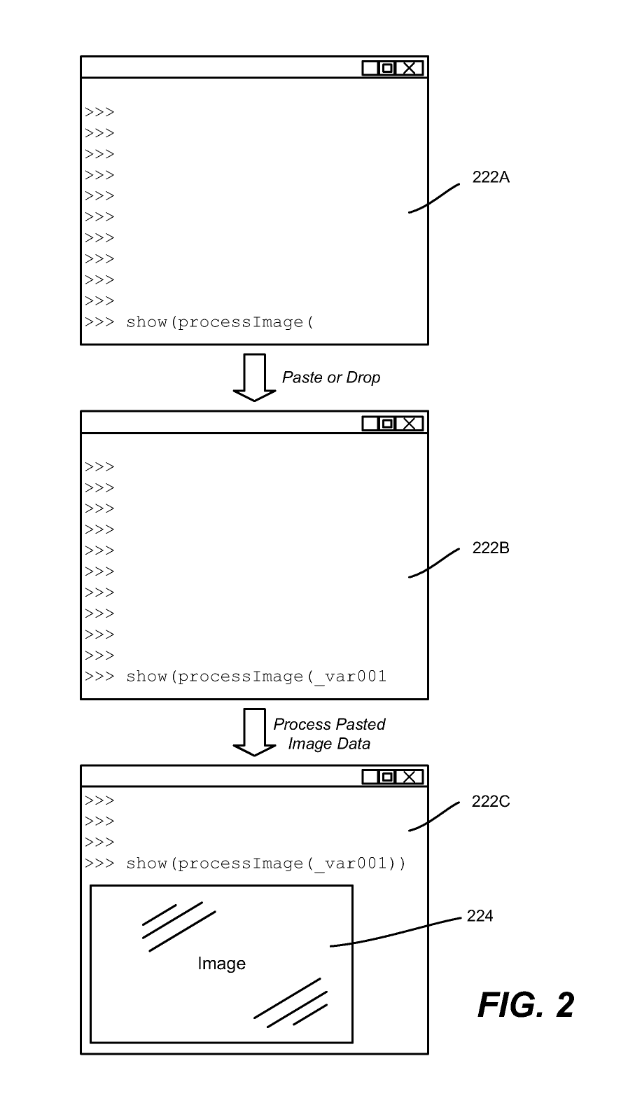

FIG. 2 shows how these operations appear on user interface screens 222A-222C in one example implementation for some image that was copied to the clipboard (or is otherwise selected and being dragged). After the user has typed the example command “show(processImage(“or the like (screen 222A), the user pastes or drops the selected data at the insertion point following this text (screen 222B). This pastes the automatically generated variable name “_var001” as text into the command line. When the user completes the line or otherwise causes the pasted variable name to be processed, the actual image data is looked up via its variable and rendered as the image 224 (screen 222C) in this example.

Note that FIG. 2 shows an example of a variable name in the form of text being inserted. However, any suitable representation may be used, such as an icon, a thumbnail, a friendly name, a timestamp and so forth, with the underlying variable name possibly hidden in whole or in part from the user.

In sum, the technology allows using the well-known paste operation (or drag-and-drop) to enter the data into the programming/data processing environment 102. Instead of literally pasting the data in at the console that can only accept text, for example, the data itself is copied into the memory of the console process, and a proxy variable is created for it, which is pasted into the console buffer. The user can then operate on this proxy variable as if it were the data itself.

Moreover, it is possible that the contents of the system clipboard 102 containing the data to be pasted may not be in a format that is desirable or useable in the programming/data processing environment 102. As described herein, a data handler 112 allows for the data to be transformed into a format that is desired or useable. For example, if the user pastes a range of data from a spreadsheet, the data pasted is not in text format (which is what appears in the clipboard), but rather may be first transformed into a structured array datatype, e.g., comma separated values, an icon representing the text, and so forth.

By way of example of how automatic insertion and data handling may provide advantages, consider a user of an interactive programming environment who wants to sort a list of numbers copied from a spreadsheet. If the amount of data is small, it can be entered directly on the command line, e.g.:
>>> sorted([1, 5, 3, 2, 4]) which results in [1, 2, 3, 4, 5].

However, if the amount of data is inconvenient, such as hundreds or thousands of numbers, the user may copy the data and then paste it into the programming environment which assigns the data to a variable, e.g., >>> sorted (_var002). Further, if the data was not in an appropriate format, a suitable data handler may be selected by the programming/data processing environment 102 to transform that data as desired, e.g., into comma separated values, rows and columns, or whatever is desired. When subsequent processing then operates on that variable, in essence treating the variable name as a proxy for the data itself, the large amount of numbers are sorted without typing in each number.

FIG. 3 shows a flow diagram having example steps in one implementation. Step 302 intercepts any paste or drop event in the user interface console to thus receive the system clipboard data. Step 304 looks for whether a suitable handler is desired and/or needed to process the data. For example, the programming environment may search a list of one or more data handlers for one that can recognize the data on the clipboard; the order of list may be configured by a user or by default. Further, if the user selects “paste special” or the like, the handler that is selected may be chosen (or the order rearranged) based on how the user chooses to paste special, (or the handlers may be bypassed with a “paste text” selection). Note that custom handlers may be developed for any programming/data processing environment, including, for example, a handler that replaces the data in an existing generated variable name.

If a suitable handler is found as determined by step 306, step 308 represents that handler transforming the data to be pasted or dropped into the program storage 110 and storing the transformed data. For example, this may comprise calling a conversion function to create an appropriately formatted object in the program storage space.

Note that if not found, step 310 represents handling the data in some other way, such as copying it as plain text. If not possible to do so, e.g., the data is some image type that cannot be handled but is recognized as inappropriate to insert as text, other possible actions include informing the user that the data is not supported, informing the user that a particular handler needs to be downloaded and installed, and so forth.

Step 312 creates a new unused variable name (e.g., _var001) that refers to the newly-created object, and step 314 maintains an association between the variable and the object. Step 316 then inserts the variable name into the user interface console at the current cursor/pointer position.

As can be seen, one implementation inserts an object corresponding to the data itself into the program storage. The data may be transformed into a format more usable from the programming environment; arbitrary data types may be “pasted” into the application, including extending a program's capabilities by adding one or more new data handlers.

Other implementations are feasible. For example, rather than use program storage, the file system may be used for object storage, but without the user having any knowledge of where the data is stored. Thus as used herein, “program storage” need not necessarily be in RAM, but may be in any storage media, including all in part in remote storage media relative to the machine on which the program is running. Some or all of the referenced data may be fetched to local storage right away, on demand, lazily or continue to be accessed from remote storage.

Various ways to give the user an option to persist a data object into the file system are feasible, including via a graphical user interface. For example, text selection of the variable name followed by further user interaction may provide the user with an interactive way (e.g., a drop-down menu) to persist the data object corresponding to the selected variable name. As another example, the user may right click or otherwise select some data such as the image 224 of FIG. 2 and be given a similar mechanism to persist that image to a file. As yet another example, another area of the program's user interface may show a graphical icon or the like representing an object, whereby the user may click on the representation of the data and be given an opportunity to persist the object. Note that such items/icons and the underlying data objects may be retained for the duration of the program, up to some maximum number, and/or until the user makes a decision on what to do with them, e.g., persist or discard.

Another alternative implementation does not necessarily require a command-line type environment. For example, consider the steps of FIG. 3 being executed on whatever data is in the clipboard when the user clicks some toolbar icon, followed by some process run on the data when loaded. As a more particular example, instead of typing “process_image(img)” into a command line, the user may simply copy an image to the clipboard, and then click an icon and/or run a macro that finds a handler (if needed), creates the variable name, puts the image object in program storage with that reference and then processes the image as appropriate for that program.

### Exemplary Operating Environment

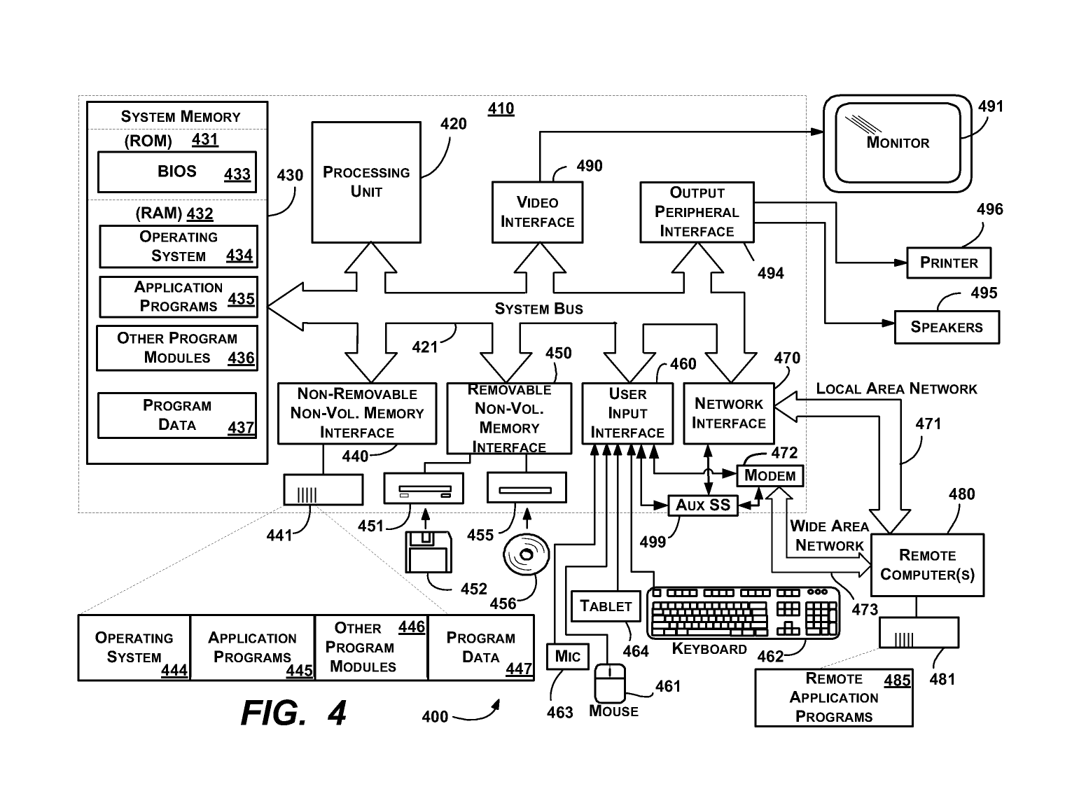

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising:
receiving selected data at a user interface of a program;
maintaining a data structure comprising the selected data or transformed data corresponding to that selected data, or both, in program storage;
generating a variable name in the current environment of the program that is not supplied by a source of the selected data;
referencing the data structure with the variable name; and
visually indicating on the user interface that the selected data has been received.

2. The method of claim 1 further comprising, receiving an instruction indicating that the selected data or transformed data is to be further processed, accessing the data structure by the variable name, and processing at least some of the data in the data structure.

3. The method of claim 1 further comprising, determining whether a handler applies to the selected data, and if so, running the handler to transform the selected data into the transformed data corresponding to the selected data.

4. The method of claim 1 wherein determining whether a handler applies to the selected data comprises searching among a plurality of handlers.

5. The method of claim 1 wherein receiving the selected data comprises receiving the selected data via a paste or drop operation, or receiving the selected data via a network communication including a network event from a networked computer or a web service, or receiving the selected data via a data event from another source, including receiving the selected data from a process, from a web browser, from a device, or via an email message or instant message.

6. The method of claim 1 wherein the user interface includes a command line, and wherein visually indicating on the user interface that the selected data has been received comprises inserting a representation of the selected data into an insertion point on the command line.

7. The method of claim 6 wherein the command line is text-only, and wherein inserting the representation of the selected data comprises inserting at least part of the variable name as text into the insertion point.

8. The method of claim 1 further comprising, detecting further user interaction with a representation of the selected data indicating that at least part of the data in the data structure is to be persisted, and persisting at least part of the data in the data structure to a file system.

9. In a computing environment, a system comprising,
a user interface into which selected data is received from a source external to the program;
processing logic that persists an object corresponding to the selected data in program storage, generates a variable name for the data object, maintains an association between the variable name and the data object, and outputs a representation of the data object to the user interface; and
a program coupled to the user interface and the processing logic to process data in the data object, including accessing the data object based upon the variable name to process at least part of the data in the data object.

10. The system of claim 9 wherein the user interface, program environment and processing logic are incorporated into a programming environment or data processing environment.

11. The system of claim 9 further comprising one or more handlers, the processing logic configured to locate a handler to transform the selected data into transformed data in another format that is maintained in the data object.

12. The system of claim 11 wherein at least one handler is a custom handler that transforms data into a format for a particular programming environment or data processing environment.

13. The system of claim 9 wherein the user interface and program comprise a Read-Eval-Print-Loop (REPL) environment including a command prompt for receiving text input.

14. The system of claim 9 wherein the user interface outputs text to a command line as the representation of the data object.

15. The system of claim 9 wherein the data object maintains text data, comma separated value data, or image data, or any combination of text data, comma separated value data, or image data.

16. One or more computer-readable media having computer-executable instructions, which when executed perform steps, comprising, receiving data at a user interface of a program comprising a programming environment, generating a variable name corresponding to the data for referencing in the programming environment, determining a handler from among a set of handlers associated with the program, running the handler to process the selected data into the transformed data, and outputting a visual indication to the user interface indicating at least one action taken with respect to the selected data.

17. The one or more computer-readable media of claim 16 having further computer-executable instructions, comprising, running a process on the transformed data.

18. The one or more computer-readable media of claim 16 having further computer-executable instructions, comprising, maintaining the transformed data in a data object and associating the data object with the variable name.

19. The one or more computer-readable media of claim 16 wherein outputting the visual indication to the user interface indicating at least one action taken with respect to the selected data comprises showing a representation indicating that the selected data has been pasted or dropped into the user interface.

20. The one or more computer-readable media of claim 16 wherein outputting the visual indication to the user interface indicating at least one action taken with respect to the selected data comprises showing text in a command line of the user interface indicating that the selected data has been pasted or dropped into the command line.
